(19) United States
(12) Patent Application Publication
(10) Pub. No.: US 2002/0174860 A1
(43) Pub. Date: Nov. 28, 2002

(54) Tile wet saw with outwardly diverging cutting mode

(76) Inventor: Martin Cullen, N. Bellmore, NY (US)

Correspondence Address: MYRON AMER, P.C., 114 Old Country Road, Suite 310, Mineola, NY, 11501, US

(21) Appl. No.: 09/864,350

(22) Filed: May 25, 2001

(51) Int. Cl. B28D 1/04; B28D 1/02

(52) U.S. Cl. 125/13.01; 125/13.03

(57) ABSTRACT

A tile wet saw tile-cutting operational mode in which a rotating circular blade depending from the saw initiates the cut upon contact incident to a first extent of movement of a pivotal traverse and completes the cut by a continued extent of movement of the pivotal traverse which widens the cut in opposite directions to thereby cut the tile in an optimum nominal time.

The present invention relates generally to improvements in the shaping of ceramic tile, such as cutting the tile in two, either parallel to a side or diagonally from one corner to an opposite corner, the latter being preparatory to the use of the shaped tile, as known in trade parlance, for a miter joint, in which more particularly the improvements significantly lessen the tedium and time consumed in the tile-shaping process.

### EXAMPLES OF THE PRIOR ART

Ceramic tiles typically are made in squares of standard sizes, such as 4×4 inches up to 18×18 inches, which reduces cost of manufacture. However, in their end use, the manufactured size often requires modification or cutting of the tile to a reduced size so that, for example, it will properly serve as the bottom row of a tiled wall, or in order to complete a miter joint, or to complement a design of standard-sized tiles by serving as a encircling border about the design, and other such circumstances. Characterizing these circumstances is that large numbers of tiles are typically involved for tiling a large area, such as a floor, or patio or bathroom walls or the like, and this correspondingly requires tile-shaping or modification which is a formidable task.

Available to achieve tile-shaping are masonry saws, as exemplified by that described and illustrated in U.S. Pat. No. 3,635,206 for “Adjustable Masonry Saw” issued to Harclerode on Jan. 18, 1972, and U.S. Pat. No. 4,055,160 for “Table Saw” issued to Wilson on Oct. 25, 1977, to mention but a few. These, and all other known tile-cutting saws have constructions and operating modes which facilitate the making of cuts at various angles, preparing the tile for the cutting operation, and other requirements of preparation for cutting, but otherwise do no significantly lessen the duration of time required to do the volume of tile-shaping that is entailed Stated somewhat differently, cutting through tile, a hard construction material, with a rotating blade, the cutting tool of choice, takes time, more time for example than cutting a softer material, such as a wood plank, and despite this circumstance, the prior art wet tile saws have not embodied any improvements which achieve the time efficiency that is achieved for cutting wood and embodied in carpenter's so-called chop saws.

Broadly, it is an object of the present invention to overcome the foregoing and other shortcomings of the prior art.

More particularly, it is an object to use to advantage the standard shape and size of a tile, which are circumstances not available for use in sawing a wood product, and in doing so achieving the same cutting time efficiency that is achieved in wood cutting, and this is despite the greater hardness and attendant difficulty in cutting tile, all as will be better understood as the description proceeds.

The description of the invention which follows, together with the accompanying drawings should not be construed as limiting the invention to the example shown and described, because those skilled in the art to which this invention appertains will be able to devise other forms thereof within the ambit of the appended claims.

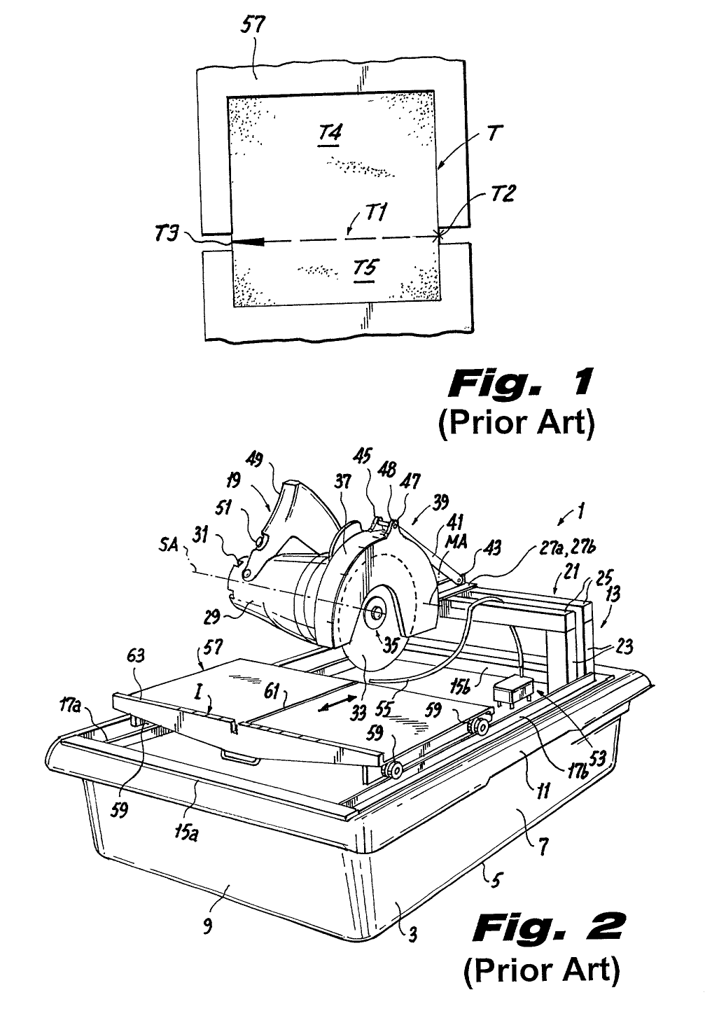

FIG. 1 illustrates the progression of the cut in a ceramic tile which results from the prior art operating mode of a tile-shaping saw;

FIG. 2 is a perspective view of an exemplary prior art saw having an operating mode producing the tile-shaping cut illustrated in FIG. 1;

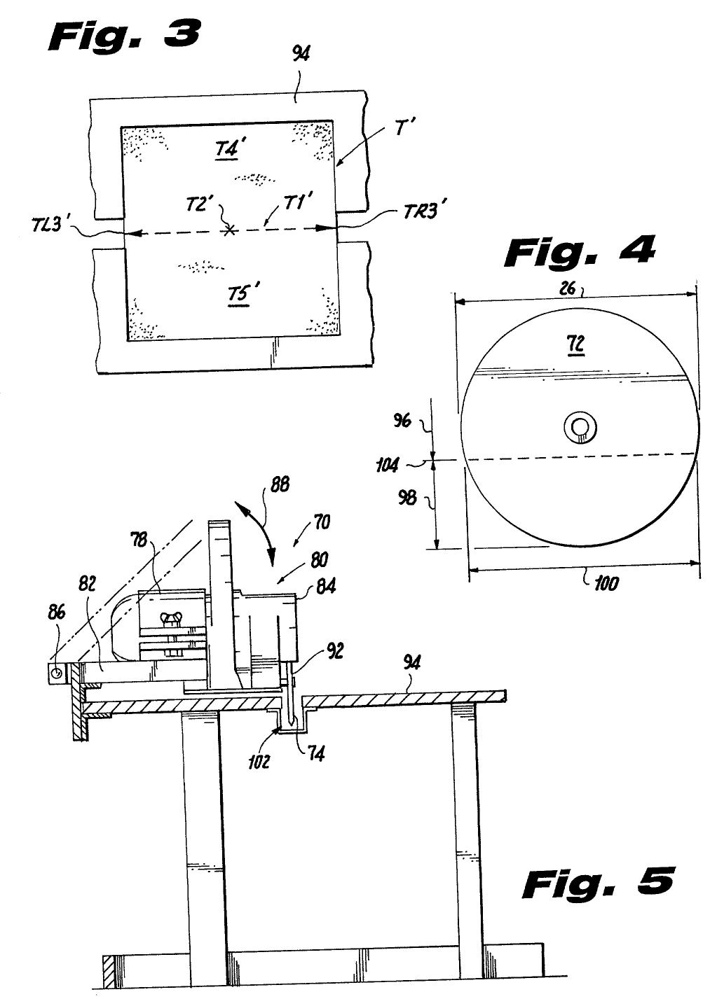

FIG. 3 illustrates a progression of the cut in a ceramic tile which results from the operating mode of a tile-shaping saw according to the present invention;

FIG. 4 is another illustration, but in greatly enlarged scale, of the tile-shaping cut of FIG. 3, and as seen in the direction of the arrows 4-4 of FIG. 6;

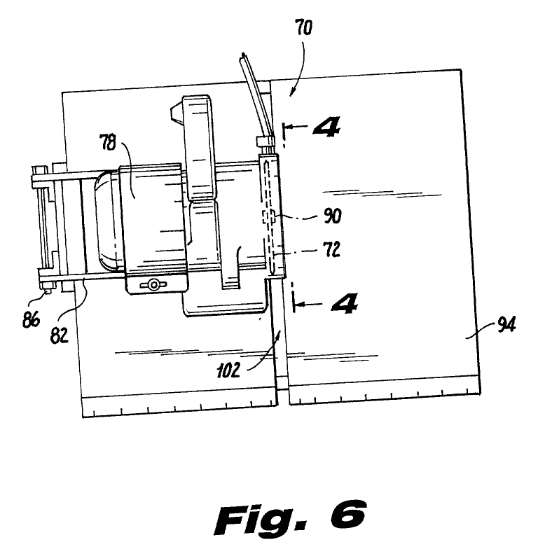

FIG. 5 is a side elevational view of a tile-shaping saw having an operating mode resulting in the illustrated tile-shaping cuts of FIGS. 3 and 4; and

FIG. 6 is a plan view of the tile-shaping saw.

As will be better understood as the description proceeds, underlying the present invention is the recognition that a popular standard size ceramic tile (6 inch square and smaller) and a popular standard size cutting tile wet saw blade (diameter greater than 6 inches) can be correlated to provide noteworthy results in the preparation of the tile for end uses, such as cutting the tile in two along a line parallel to a side or on a diagonal from corner to corner as needed in a miter joint.

In the above regard, the typical six inch square tile T, depicted in FIG. 1, is cut along the cutting path T1, starting at the starting point T2 to the end of the path T3, resulting in the separated two parts T4 and T5, wherein the cutting in two is in accordance with the operating mode of the FIG. 2 prior art wet saw, generally designated 1, and soon to be described in detail, as is also the typical six inch square tile T′, depicted in FIG. 3, cut in two parts T4′ and T5′, along a cutting path T1′, but in the latter instance, the cutting path starts at a medial location, as at T2′, and progresses outwardly in the opposite directions TL3′ and TR3′, and is in accordance with the operating mode of the wet saw, generally designated 70, of the present invention, soon to be described in detail and in reference to FIGS. 4-6. The cutting paths T3 and TL3′, TR3′, although both effective in producing the separation in two of a typical standard sized tile T, T′, are otherwise substantially distinguishable, the latter or that of applicant taking considerably less time and effort.

Referring now to the drawings, and for background and comparison first particularly to prior art FIG. 1, a portable, direct drive abrasive or diamond saw is generally indicated by reference character 1.

The portable saw is shown to include a base pan, as generally indicated at 3. The base pan includes a bottom wall 5 opposite sidewalls 7 and end walls 9. A rolled over lip 11 extends around the upper edges of the side and end walls thus providing a convenient fingerhold for carrying the base pan. It will be understood that the base pan thus constitutes a reservoir for holding a quantity of coolant (e.g., water) which is circulated over the abrasive saw blade for cooling the saw blade and the work while the work is cut by the portable saw.

Under normal operating conditions, the coolant reservoir will normally be filled with approximately 7 gallons of water.

A frame, as generally indicated at 13, is mounted within base pan 3 and is secured thereto. The frame includes a pair of opposite end members 15a, 15b formed of angle iron or the like disposed with the upper flange of the angle irons extending outwardly away from one another and with the other legs of the angles extending downwardly and adapted to be positioned on the inside of end walls 9. The underface of the upper flanges of these end members bear on the upper edge of lip 11 and thus support the frame within the base pan. Suitable fastener means, such as bolts or screws (not shown), may be inserted through the upper flanges of end members 15a, 15b thereby to secure frame 13 to the base pan.

Frame 13 is shown to further comprise a pair of rails 17a, 17b spaced apart from one another and extending longitudinally the length of base pan 3 between opposite end members 15a, 15b. Again, rails 17a, 17b are shown to be of angle iron construction oriented with one flange extending vertically and with a horizontal flange extending outwardly toward the inside faces of adjacent sidewalls 7. The upper edges of the vertical flange of these rail members constitute track or rail surfaces for purposes as will appear.

Further, portable saw 1 includes a unitary, direct drive, rotary saw assembly, as generally indicated at 19, fixedly positioned by frame 13. The frame includes a saw support, as generally indicated at 21, at the end of the frame adjacent end member 15b. Saw support 21 is shown to comprise a pair of vertical supports 23 spaced apart from one another and at each side of the frame secured (e.g., welded) to respective rail members 17a, 17b and extending vertically above the upper edge of the vertical flange of the rail members. Horizontal support members 25 extend transversely of the frame from the upper end of one vertical support member 23 to the upper end of a corresponding vertical support member on the opposite side of the frame. Again, vertical members 23 and horizontal members 25 are of angle iron construction and the horizontal transverse members 25 are oriented so as to have their upper flanges in generally horizontal position and vertical flanges extending downwardly with the horizontal upper flanges constituting a generally planar mounting surface.

A pair of cantilever arms 27a, 27b is mounted on the upper faces of horizontal arms 25 so as to extend in cantilever fashion generally horizontally inwardly of the frame from the saw support 21 out over the center portion of the frame above base wall 5 of base pan 3. These cantilever arms 27a, 27b are shown to be a pair of spaced apart angle iron members secured to the horizontal members 25 in back-to-back relation.

The unitary direct drive saw assembly 19 is shown preferably to comprise a lightweight saw assembly, such as a hand held circular power saw, including a housing 29. An induction electric motor, as indicated at 31, is mounted within housing 29 so as to directly drive an abrasive saw blade 33 about a saw axis, as indicated at SA in FIG. 2, for cutting a tile T. As is conventional with a saw unit such as 19, a suitable direct drive gear train (not shown) consists of motor 31 and the drive shaft for saw blade 33. As indicated at 35, a removable saw blade mounting arbor and locking bolt assembly is provided for readily permitting the removal of one saw blade and the installation of another on the drive shaft of the saw.

Saw 19 is provided with a saw blade guard 37 at least partially enclosing the saw blade and protecting users of the saw from inadvertently touching the rotating saw blade 33 while in operation. Saw 19 is pivotally mounted on cantilever arms 27 by means of a mounting bolt inserted through a boss provided on the housing 31 of the saw and extending through corresponding holes in the cantilever saw support arms 27a, 27b. In this manner, the saw 19 is rotatable about a mounting axis MA extending longitudinally through the center of the bolt whereby the saw axis SA extending through the rotary axis of saw blade 13 pivots relative to axis MA and thus is eccentrically mounted with respect to frame 13 for permitting vertical adjustment of the saw blade relative to the frame and the table.

Further, saw 17 is held in a desired adjusted position or height by means of a locking arrangement, as generally indicated at 39, including a strap 41 pivotally secured at its outer end to cantilever arms 27 by a pivot bolt 43. The strap 41 extends rearwardly and has an elongate slot 45 in its rear end portion. A bolt 47 is inserted through a hole in a boss 48 on the upper surface of guard 3. Bolt 47 is received in the elongate slot 45 and, upon tightening bolt 47, the guard assembly 37 and hence the saw assembly 19 is clampingly held in fixed position relative to bar 41 thus locking the saw assembly in a desired vertical position relative to the frame.

In accordance with its operating mode, saw assembly 19 is suitably modified to electrically ground all parts of the saw (e.g., the motor, the guard 37, and other metal components) so as to reduce the potential of electrical shock hazard to the user. Saw housing 29 further includes a handle 49 and an on/off toggle switch 51 is provided on the handle in a convenient location for operation by the user to energize and de-energize motor 31 and pump 53 at the same time.

An electrically operable, submersible pump, as generally indicated at 53, is located within base pan 3 for circulating coolant within the base pan to the rotating saw blade via coolant lines 55 leading from the pump to outlet nozzles on saw blade guard 37.

A work support table 57 is rollingly mounted on rail members 17a, 17b for translation in horizontal direction between a retracted position (as shown in solid lines in FIG. 2 in which the tile T supported on the upper face of table 57 and the table is clear of the cutting surfaces of saw blade 33 and a cutting position in which the saw blade cuttingly engages the work. The table is movable to its full cutting position such that the saw blade 33 may fully cut through tile T supported on the table. Table 57 is rollingly supported on the upper edges of the vertically extending flanges of rail members 17a, 17b by means of four steel rollers 59. A center groove 61 is provided in the work table extending down below the work supporting upper surface of the table for accommodating the lower periphery of saw blade 33 as the work table is moved from its retracted position to its full cutting position and as the saw blade cuts through the work supported on the table. A rear flange 63 is provided at the rear of the table with the flange extending above the height of the work supporting surface whereby the tile T to be cut (e.g., a ceramic tile) may be properly aligned and held square with respect to the table so as to insure a true and square cut by saw blade 33 as the work support table is manually moved from its retracted to its cutting position. In addition, indicia I (see FIG. 2) may be provided on the upper surface of flange 63 so that the dimensions of the work to be cut may be readily measured by referring to the indicia.

The tile wet saw 70 of FIGS. 5 and 6 will be understood to be similarly constructed so as to be capable of cutting ceramic tile as described in connection with the saw 1 of FIG. 2 and thus, for brevity sake, the description of this construction will not be duplicated, and what will be described is the construction and operating mode of the saw 70 of FIGS. 5 and 6 which produces the separation of the tile T′ in two parts T4′ and T5′ in considerably less time and effort as previously noted.

To provide cutting service to the saw 70, use is made of a circular blade 72 having a peripheral cutting edge 74 and of a selected diameter 76 of at least approximately six inches, wherein the blade 72 is powered in rotation by an electric motor 78 within a housing 80 having opposite ends 82 and 84. At one end 82 are pivot means 86 for mounting the housing 80 to partake of pivotally traversing movement 88 and at the opposite end 84 are means, as at 90, for journalling the blade 72 for rotation and in extending relation, as depicted at 92, depending from the housing 80.

A ceramic tile T′, of the selected six inch square configuration, is supported on a tile support 94 which provides a positioning location at an end of and in aligned relation to the path of the pivotal traversing movement 88 of the housing.

As a consequence, the thusly positioned tile T′ is adapted to be contacted by the cutting blade cutting edge 74 initially centrally, as at T2′, of the proposed tile-separating cut T1′ during the initial pivotal traversing descent 96, and during continued pivotal traversing descent 98, as best understood from FIG. 4, so that the tile-separating cut T1′ progressively enlarges in opposite outward directions TL3′ and TR3′, until the tile T′ is shaped into two parts T4′ and T5′, which in practice has been noted to occur in an optimum nominal time.

Stated somewhat differently, the simultaneous opposite direction outward progression of the tile severing cut T1′ of a pivotal traverse 88 is achieved in significantly less time than the prior art tile severing cut T1 which starts at a site T2 at one end and progresses only in one direction therefrom until the end T3 of the cut is reached, this prior art shortcoming resulting from urging the tile in longitudinal movement Ti in relation to the rotating cutting blade 33 having no pivotal traversing degree of movement, whereas in contrast, the cutting of the tile with a pivotal traverse is effective to produce cutting of the tile simultaneously in outward opposite directions from the site T2′ and completes a total 6 inch cut when a chord 100 of the blade of a 6 inch dimension, which is the size of the tile cut needed to separate the tile in two, descends through the plane 104 of the tile into the notch 102.

It is preferred that by appropriate diameter size 76 selection for the blade 72 that the tile T′ be severed in two T4′, T5′ by descent of the blade 72 through the plane 104 of the tile T′ to the extent necessary, but as an alternative, and not shown since the instructions which follow suffice for one well versed in the art, the stationary tile support 94 can be converted to a carriage by being embodied with wheels tracking in transverse tracks so that the tile support 94 can be urged in nominal opposite linear movements to complete the cut through the tile end length potions not cut in the blade descent.

While the apparatus for practicing the within inventive tile-severing method herein shown and disclosed in detail is fully capable of attaining the objects and providing the advantages hereinbefore stated, it is to be understood that it is merely illustrative of the presently preferred embodiment of the invention and that no limitations are intended to the detail of construction or design herein shown other than as defined in the appended claims.

What is claimed is:

1. A saw capable of shaping a 6 inch square ceramic tile comprising for providing cutting service to said saw a circular blade having a peripheral cutting edge and of a diameter of at least 6 inches, motor means connected to power said circular blade in rotation, a saw housing having opposite ends, means at one end for mounting said housing for pivotally traversing movement, means at said opposite end for journalling said circular blade for rotation in extending depending relation therefrom, a ceramic tile at least of a 6 inch square configuration, and a tile support in positioning relation to said tile having an operative position located at an end of and in aligned relation to said path of said pivotal traversing movement of said housing, whereby said tile is adapted to be contacted by said cutting blade centrally of a proposed cut therein during initial pivotal traversing descent and during continued pivotal traversing descent said cut in said tile progressively enlarges in opposite outward directions until said tile is shaped into two parts in an optimum nominal time.
